(19) United States
(12) Patent Application Publication
(10) Pub. No.: US 2017/0101066 A1
(43) Pub. Date: Apr. 13, 2017

(54) Ornamental Decorations for the Exterior of a Motor Vehicle

(71) Applicant: Cynthia Diane Garrett, Gardena, CA (US)

(72) Inventor: Cynthia Diane Garrett, Gardena, CA (US)

(21) Appl. No.: 14/881,926

(22) Filed: Oct. 13, 2015

(51) Int. Cl. B60R 13/04; B60Q 1/00

(52) U.S. Cl. CPC B60R 13/04; B60Q 1/0035; B60Y 2410/113

(57) ABSTRACT

An apparatus for decorating a vehicle with holiday ornaments. The preferred embodiment of the invention is to affix a series of ornaments to the exterior of the vehicle by suction cups inside the vehicle doorjamb on opposite sides, which are not visible from the exterior, and a string or wire connecting both suction cups. The ornaments are affixed to the wire and are preferably magnetic, so that they will remain in place as arranged by the user. The ornaments may be optionally lighted using battery or solar power.

### CROSS-REFERENCE TO RELATED APPLICATIONS

This Application is related to and claims the benefit of Provisional Application 62/063,146.

### STATEMENT REGARDING FEDERALLY SPONSORED RESEARCH OR DEVELOPMENT

N/A

### SEQUENCE LISTING, TABLE, OR COMPUTER PROGRAM LISTING

N/A

### REFERENCE TO “MICROFICHE APPENDIX”

N/A

### TECHNICAL FIELD

### Ornamental decorations

### BACKGROUND ART

Several patents have been issued for seasonal and non-seasonal vehicle decorations, primarily using a flagpole or “stanchion” to affix a vertical decoration to the exterior of a vehicle in the vehicle window or hood assembly.

### BACKGROUND OF THE INVENTION

The product provides a mechanism to semi-permanently affix ornamental decorations to the exterior of a motor vehicle or other object in a manner that allows them to be easily removed or repositioned by the user, but prevents removal or theft by others with access to the motor-vehicle exterior.

The product combines an interior suction assembly with strings or wires and potentially magnetized ornaments in a novel and unique manner, which prevents third parties from accessing the mechanism that secures the ornaments, and permits re-positioning and removal the user, allowing seasonal or temporary use of the product.

### BRIEF SUMMARY OF THE INVENTION

The product is primarily for seasonal, holiday decorations attached to the exterior of a vehicle door. The decorations are held in place by magnets on the exterior of the vehicle and suction on the interior of a vehicle door assembly, one or a series of wires on the exterior of the vehicle door, and ornamental magnets. The objective of the product is to provide securely fastened assembly of holiday decorations to the exterior of a vehicle door that do not scratch or mark the surface of the vehicle door, cannot be easily removed by passers by, but can be removed or repositioned by the vehicle owner.

For example, the product may comprise a series of magnets in the shape of Christmas bulbs, sleigh bells, or Christmas lights (either in flat or three-dimensional form, and potentially illuminated) during the Christmas season, on the driver and passenger sides, hoods, and trunk of the vehicles, a series of colored eggs at Easter, a series of American flags for Independence Day, or a series of Jack-o-Lantern's at Halloween.

### BRIEF DESCRIPTION OF THE DRAWINGS

For a further understanding of the nature, objects and advantages of the present invention, reference should be had to the following detailed description, read in conjunction with the following drawings:

Figures

FIG. 1 is a side view of the entire product assembly, including the suction mechanism for attachment to the vehicle, the wire assembly, and magnetic ornaments.

FIG. 2 is a detail view of the suction attachment mechanism on the forward portion of the vehicle door assembly.

FIG. 3 is an exploded view of the suction attachment mechanism for the rear portion of the vehicle door assembly, including the powered mechanism.

FIG. 4 is a detail view of the ornaments as attached to the exterior of a vehicle door.

FIG. 5 is an exterior view of a vehicle door with the assembly installed.

References

| | | | |
|---|---|---|---|
| 10 | suction mechanism | 12 | suction mechanism |
| 14 | wire or string | 16 | ornaments |
| 20 | suction mechanism | 22 | wire or string |
| 30 | suction mechanism | 32 | wire |
| 34 | battery | 36 | housing |
| 38 | switch | | |
| 40 | ornament | 42 | ornament |
| 44 | ornament | 46 | wire or string |
| 50 | wire or string | 52 | ornaments |

### DETAILED DESCRIPTION OF THE INVENTION

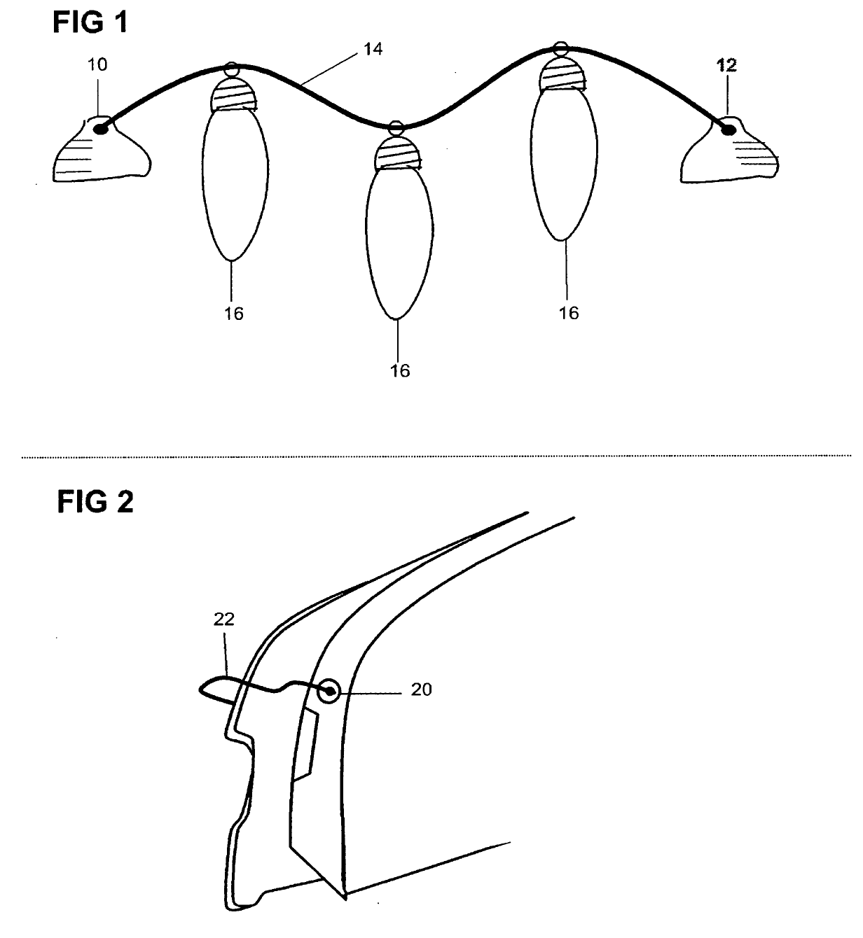

FIG. 1 shows a side view of the full product prior to installation. Assemblies 10 and 12 (preferably suction cups) are attached through one or more connecting wires or strings 14. A series of ornaments 16 are attached to the connecting wires or strings between the assemblies.

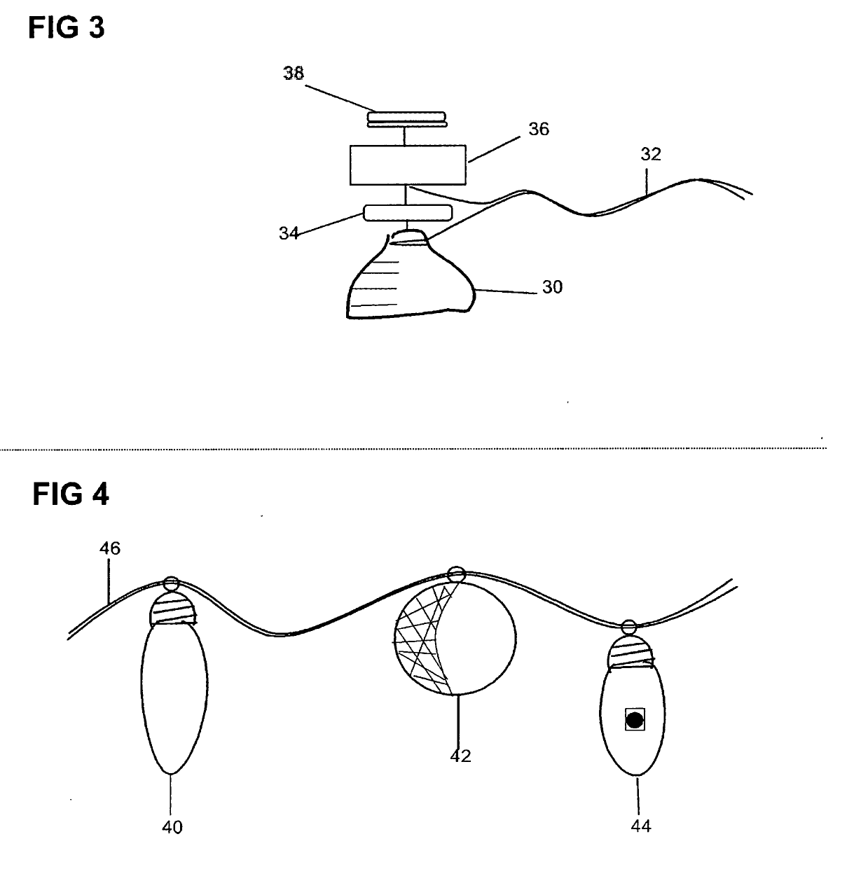

When installed, as detailed below, the assemblies are, preferably, firmly affixed to the interior of the doorjamb on either side of the vehicle door (as shown in FIGS. 2 and 3). Other placements are also feasible, e.g., inside of the vehicle window, hood, trunk assemblies, directly to the exterior of the vehicle or windshield/windows, on the interior of the vehicle. Other interior and exterior uses of the invention are also available, for example on watercraft, recreational vehicles, and home windows.

The strings or wires are threaded through the magnets on the exterior of the vehicle, preferably through the space between the door of the vehicle and the exterior. The user then positions the ornaments in his/her desired arrangement on the exterior of the vehicle. In the preferred embodiment, the ornaments are magnetized or otherwise adhesive in a manner that does not damage, scratch or mar the vehicle exterior, allowing the user to semi-permanently affix the ornaments in the desired arrangement. Preferably, the user when desired can easily remove the ornaments and the assemblies.

Optionally, one of the assemblies will include a power source, preferably a battery or solar power source, and a switch. In this optional configuration, the wires attaching the two assemblies will he electrical wires, connected to a light source (preferably a light emitting diode) on some or all of the ornaments. This will allow the ornaments to light up, and will preferably allow the user to turn on and off the lights as desired.

The preferred embodiment is to affix the assemblies 10 and 12 to a car, truck or other vehicle, but other applications are also possible, for example on watercraft. The user may easily remove the invention by removing the assemblies 10 and 12 from the vehicle, and the invention may be collapsed for storage and future use.

The preferred method of semi-permanently attaching the invention to the vehicle is shown in FIGS. 2 and 3. In FIG. 2, the attachment assembly is firmly affixed in the vehicle doorjamb to the exposed portion of the front of the vehicle door, preferably through a suction mechanism 20 and magnets on the exterior of the vehicle, although other means of attachment (e.g., by adhesives or tape) may be used. The wire or string 22 is then threaded through the magnets on the outside of the vehicle through the space between the door and the vehicle exterior.

FIG. 3 shows the other attachment assembly on the rear portion of the vehicle door. The assembly 30 is semi-permanently attached (preferably by suction) to the metal portion of the vehicle door inside the rear doorjamb. Again, other methods of attachment, e.g., adhesives or tape, may be used. As in FIG. 2, the wire or string 32 is threaded through he doorjamb to the exterior of the vehicle.

In the preferred embodiment, the assemblies 20 and 30 (FIGS. 2 and 3) are attached on opposing sides of the vehicle doorjamb, with the wire or string 22 and 32 (FIGS. 2 and 3) hanging freely (preferably horizontally) on the exterior of the vehicle between them. Other methods of installation are possible, including, for example, attachment directly to the exterior of the vehicle, through window, trunk or hood assemblies, or affixed to the vehicle windows. The user may also choose to hang the wire or string on the interior of the vehicle, and would do so by threading the wire or string through to the interior of the vehicle rather than the exterior.

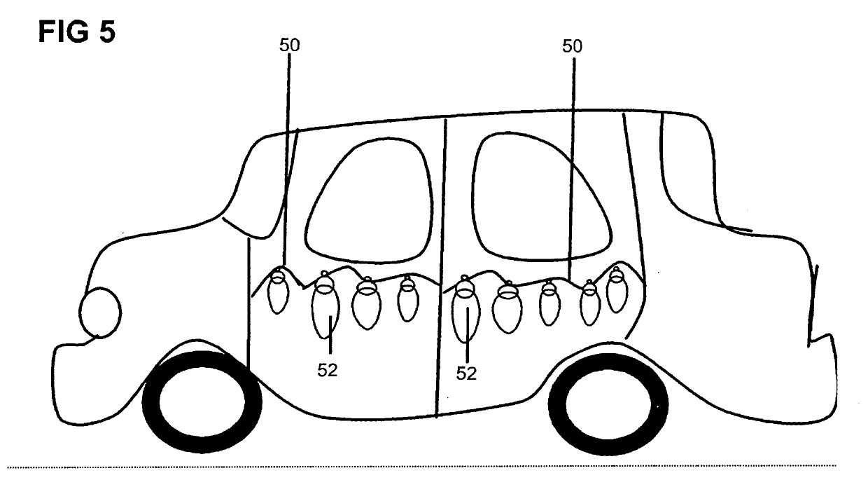

FIG. 3 also shows an optional powered assembly 34, including a power source (preferably a battery) and a switch. As described above, the power source will be optionally used to power a light source in one or more of the ornaments (see FIG. 4.) The switch will allow the user to turn on and off the light source.

FIG. 4 shows the attachment of the ornaments 40, 42 and 44, to the string or wires 46. The ornaments in one invention may he similar or different, giving a whimsical impression. In the preferred embodiment, the ornaments 40 are magnets or are otherwise adhesive, and will not damage, scratch or mar the vehicle exterior. They will be semi-permanently attached to the exterior of a vehicle in an arrangement chosen by the user.

The ornaments may be flat, rounded or in other three-dimensional shapes, and flat and three-dimensional ornaments may be combined in a single product. In the preferred embodiment, the flat ornaments 40 are cut in the shape of the ornament, and are either magnetic in their entirety or are magnetic or adhesive on one side attached to the vehicle. Where only one side is magnetic or adhesive, the opposite, outward facing side will reflect the style of ornament through drawings and colors depicting the season.

The rounded, three-dimensional ornaments 42 will preferably he magnetic or adhesive on one side, or may have an attached magnet or adhesive strip. The magnetic or adhesive portion will be semi-permanently attached to the vehicle in the users desired arrangement. Preferably. the entire three-dimensional ornament will be decorated, and the magnet will be inside the ornament so that it is not visible.

One or more of the ornaments 44 will also optionally include a light source (preferably a light emitting diode), which will be powered by a power source on the assemblies (FIG. 3.) The lighted ornaments may be flat, rounded or three-dimensional shapes, and may be combined with unlighted flat and/or three-dimensional ornaments.

FIG. 5 shows the preferred embodiment of the invention as installed on the exterior of a vehicle door. The assemblies are not shown, and would be hidden from view inside the vehicle doorjamb. The string or wire 50 assures that the ornaments 52 remain affixed to the vehicle. The ornaments 52 will preferably be magnetic or adhesive, and will remain in place as arranged by the user. The user may, from time to time, change the arrangement by removing and rearranging the ornaments without the need to remove the entire assembly from the vehicle. Although the preferred embodiment is on the exterior of a vehicle, other users are suitable as described above.

1. An apparatus for attaching decorative ornaments to the outside of a vehicle, the apparatus comprising:
an assembly of two suction cups or adhesive strips, affixed to opposite sides of a vehicle door assembly;
one or more wires extending outside of the vehicle door assembly to the exterior of the vehicle; and
a plurality of decorative ornaments firmly affixed to, and hanging vertically from, the wire or wires.

2. The apparatus of claim 1, in which the decorative ornaments are holiday bulbs.

3. The apparatus of claim 1, in which the decorative ornaments are holiday lights.

4. The apparatus of claim 1, in which the decorative ornaments are representations of holiday characters or symbols.

5. A method of decorating a vehicle with the apparatus described in claim 1.

6. An apparatus for attaching decorative ornaments to the outside of a vehicle, the apparatus comprising:
an assembly of two suction cups or adhesive strips, affixed to opposite sides of a vehicle door assembly;
one or more wires extending outside of the vehicle door assembly to the exterior of the vehicle; and
a plurality of magnetic decorative ornaments firmly affixed to, and hanging vertically from, the wire or wires.

7. The apparatus of claim 6, in which the decorative ornaments are holiday bulbs.

8. The apparatus of claim 6, in which the decorative ornaments are holiday lights.

9. The apparatus of claim 6, in which the decorative ornaments are representations of holiday characters or symbols.

10. A method of decorating a vehicle with the apparatus described in claim 6.

11. An apparatus for attaching lighted decorative ornaments to the outside of a vehicle, the apparatus comprising:
an assembly of two suction cups or adhesive strips, affixed to opposite sides of a vehicle door assembly, one of which contains a battery and switch;
one or more electrical wires extending outside of the vehicle door assembly to the exterior of the vehicle; and
a plurality of decorative ornaments containing lights attached to, and hanging vertically from, the wire or wires, powered by the battery.

12. The apparatus of claim 11, in which the decorative ornaments are holiday bulbs.

13. The apparatus of claim 11, in which the decorative ornaments are holiday lights.

14. The apparatus of claim 11, in which the decorative ornaments are representations of holiday characters or symbols.

15. The apparatus of claim 11 where the power source is a solar power source affixed to the exterior of the vehicle in lieu of a battery.

16. A method of decorating a vehicle with the apparatus described in claim 11.
